(19) United States
(12) Patent Application Publication
(10) Pub. No.: US 2025/0386071 A1
(43) Pub. Date: Dec. 18, 2025

(54) METHOD, APPARATUS, DEVICE, MEDIUM AND PROGRAM PRODUCT FOR BROWSING VIDEOS

(71) Applicant: Beijing Zitiao Network Technology Co., Ltd., Beijing (CN)

(72) Inventor: Zhanchen ZHANG, Beijing (CN)

(21) Appl. No.: 19/241,133

(22) Filed: Jun. 17, 2025

Related U.S. Application Data
(63) Continuation of application No. PCT/CN2024/099681, filed on Jun. 17, 2024.

(51) Int. Cl. H04N 21/422; H04N 21/431; H04N 21/482

(52) U.S. Cl. CPC H04N 21/42216; H04N 21/4312; H04N 21/482

(57) ABSTRACT

Embodiments of the present disclosure relate to method, apparatus, device, equipment, medium, and program product for browsing videos. The method includes displaying a video and a set of interactive buttons related to the video on a display screen, wherein the set of interactive buttons are arranged in a first direction on the display screen. The method also includes in response to receiving a first control signal from a first control key of a controller for the display screen corresponding to the first direction, switching the selection of one of a set of interactive buttons. The method also includes in response to receiving a second control signal from a second control key of the controller corresponding to a second direction, switching the displayed video, wherein the first direction is different from the second direction.

### CROSS-REFERENCE TO RELATED APPLICATIONS

This application is a continuation of International Patent Application No. PCT/CN2024/099681, entitled “METHOD, APPARATUS, DEVICE, MEDIUM AND PROGRAM PRODUCT FOR BROWSING VIDEOS” and filed on Jun. 17, 2024, the disclosure of which is incorporated herein by reference in its entirety.

### FIELD

The embodiments of the present disclosure generally relate to the field of video processing, and specifically to method, apparatus, device, medium and program product for browsing videos.

### BACKGROUND

The interaction between a television (TV) and a remote control is a key area in the development of TV technologies. Its technological evolution not only reflects the trend of TV intelligence and convenience, but also causes many new technologies. From an initial infrared communication technology to modern intelligent voice and gesture recognitions, the interaction between the TV and the remote control is becoming more diversified and intelligent. This not only improves the user's viewing experience, but also injects new vitality into the development of the TV industry.

Now, the interaction between the TV and the remote control has integrated a variety of advanced technologies, realizing a more accurate and convenient interaction method, providing users with an unprecedented good experience. With the development and application of new technologies, it has further promoted the innovation of the TV and remote control interaction technology. However, there are still many technical problems that need to be solved in controlling TV videos with a remote control.

### SUMMARY

Embodiments of the present disclosure provide a method, apparatus, device, medium and program product for browsing videos.

According to a first aspect of the present disclosure, a method for browsing videos is provided. The method includes displaying a video and a set of interactive buttons related to the video on a display screen, wherein the set of interactive buttons is arranged in a first direction on the display screen. The method also includes in response to receiving a first control signal from a first control key of a controller for the display screen corresponding to the first direction, switching a selection of one the set of interactive buttons. The method also includes in response to receiving a second control signal from a second control key of the controller corresponding to a second direction, switching the displayed video, wherein the first direction is different from the second direction.

In a second aspect of the present disclosure, a device for browsing videos is provided. The device includes a display module configured to display a video and a set of interactive buttons related to the video on a display screen, wherein the set of interactive buttons is arranged in a first direction on the display screen; an interactive button switching module configured to in response to receiving a first control signal from a first control key of a controller for the display screen corresponding to the first direction, switch a selection of one of the set of interactive buttons; and a video switching module configured to in response to receiving a second control signal from a second control key of the controller corresponding to a second direction, switch the displayed video, wherein the first direction is different from the second direction.

In a third aspect of the present disclosure, a display device is provided, comprising at least one processor; and a memory having at least one program stored thereon which, when executed by the at least one processor, causes the at least one processor to implement the method according to the first aspect of the present disclosure.

In a fourth aspect of the present disclosure, a non-transitory computer-readable storage medium is provided. The non-transitory computer-readable storage medium having a computer program stored thereon which, when executed by the processor, causes the processor to implement the method according to the first aspect of the present disclosure.

In a fifth aspect of the present disclosure, a computer program product is provided. The computer program product includes a computer program which, when executed by a processor, causes the processor to implement the method according to the first aspect of the present disclosure.

It should be understood that the contents described in this summary are not intended to limit the key or important features of the embodiments of the present disclosure, nor are they intended to limit the scope of the present disclosure. Other features of the present disclosure will become easier to understand through the following description.

### BRIEF DESCRIPTION OF THE DRAWINGS

The above and other purposes, features and advantages of the present disclosure will become more apparent through a more detailed description of the exemplary embodiments of the present disclosure in conjunction with the drawings, wherein the same reference numerals generally represent the same components in the exemplary embodiments of the present disclosure.

FIG. 1 illustrates a schematic diagram of an example environment in which the devices and/or methods of embodiments of the present disclosure may be implemented;

FIG. 2 illustrates a schematic diagram of an example for browsing videos according to embodiments of the present disclosure;

FIG. 3 illustrates a schematic diagram of an example of video switching according to embodiments of the present disclosure;

FIG. 4 illustrates a schematic diagram of an example of interactive buttons according to embodiments of the present disclosure;

FIG. 5 illustrates a schematic diagram of an example of switching interactive buttons according to embodiments of the present disclosure;

FIG. 6 illustrates a schematic diagram of an example for switching videos and interactive buttons according to embodiments of the present disclosure;

FIG. 7 illustrates a schematic diagram of an example of a mesh interactive structure according to embodiments of the present disclosure;

FIG. 8 illustrates a schematic diagram of a method of browsing videos according to embodiments of the present disclosure;

FIG. 9 illustrates a schematic block diagram of an apparatus for browsing videos according to embodiments of the present disclosure;

FIG. 10 illustrates a schematic block diagram of an example device suitable for implementing embodiments of the present disclosure.

In the various drawings, the same or corresponding reference numerals represent the same or corresponding parts.

### DETAILED DESCRIPTION OF EMBODIMENTS

It is understood that the data involved in the subject matter (including but not limited to the data itself, the acquisition or use of the data) shall comply with the requirements of relevant laws, regulations and relevant provisions. In response to receiving a user's active request, a prompt message is sent to the user to clearly prompt the user that the operation requested to be performed will require the acquisition and use of the user's personal information. Thus, the user can autonomously choose whether to provide personal information to an electronic device, an application, a server or a storage medium or other software or hardware that performs operations of subject matters of the present disclosure according to the prompt message.

The embodiments of the present disclosure will be described in more detail with reference to the drawings. Although certain embodiments of the present disclosure are shown in the drawings, it should be understood that the present disclosure can be implemented in various forms and should not be construed as being limited to the embodiments described herein. On the contrary, these embodiments are provided for a more thorough and complete understanding of the present disclosure. It should be understood that the drawings and embodiments of the present disclosure are for illustrative purposes only and are not intended to limit the scope of protection of the present disclosure.

In the description of the embodiments of the present disclosure, a term “including” and similar terms should be understood as open inclusion, that is, “including but not limited to.” A term “based on” should be understood as “based at least in part on.” A term “one embodiment” or “the embodiment” should be understood as “at least one embodiment.” The terms “first,” “second,” etc. may refer to different or the same objects. The following may also include other explicit and implicit definitions.

As mentioned above, there are still many technical problems that need to be solved in controlling TV videos using remote controls. For example, at present, video browsing functions in large-screen display devices of internet products are mainly divided into two parts: one is video playback, and the other is interactive functions. On large-screen display devices, characteristics of traditional products and technical structures are that video playback is in a first level, and all other functions are hidden in a second level. When users perform interactions, they need to use the controller to trigger the interactive function level (usually pause, or left and right keys to control progress).

However, the traditional solution has following problems. For example, the traditional tree-like interactive structure on the TV side will limit the convenience of using content and efficiency and convenience of an interactive access, because this structure often requires users to jump between different levels multiple times. If the users want to use the remote control to complete the video switching or frequent interactive accesses on the large screen, the users need to repeatedly operate the remote control. This experience may be very inconvenient for the users and cause inconvenience to the users.

At least to solve the above and other potential problems, embodiments of the present disclosure propose a method for browsing videos. In this method, a display device simultaneously displays a video and a set of interactive buttons related to the video on a display screen, wherein the set of interactive buttons are arranged in a row on the display screen. If the computing device receives a first control signal from a first control key of a controller for the display screen corresponding to a first direction, the selection of the interactive button is switched at this time. If a second control signal from a second control key for the controller corresponding to a second direction is received, the displayed video is switched, wherein the first direction is different from the second direction. Through this method, when a user uses a controller to interact, the user can not only conveniently switch videos for browsing, but also efficiently use all interactive buttons, thereby improving usage efficiency and user experience.

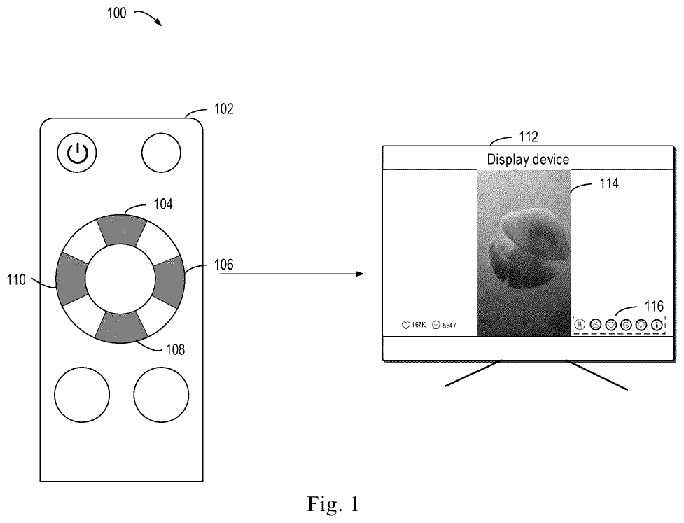

The embodiments of the present disclosure will be described in detail below in conjunction with the drawings. FIG. 1 shows an example environment in which the device and/or method of the embodiments of the present disclosure may be implemented. In an environment 100, a display device 112 is used to receive a control signal from a controller 102 to control a video and/or interactive buttons displayed on the display device 112.

Examples of display device 112 include, but are not limited to, televisions, display devices with set-top boxes, projectors, and other devices. As shown in FIG. 1, the display device 112 has a display screen for displaying video contents that may be browsed by users, such as a video 114. In addition to displaying the video contents, a set of interactive buttons 116 may also be displayed on the display screen at the same time. In order to facilitate the users to browse videos and interact with the interactive buttons, the displayed videos and the interactive buttons are arranged on a same display layer. In addition to browsing the videos, the users may also perform interactive operations by using the set of interactive buttons at the same time. Additionally, in order to further facilitate the use of direction-related control keys to control the set of interactive buttons, the set of interactive buttons are arranged on the display screen in a first direction. In one example, when the first direction is horizontal, the set of interactive buttons is arranged in a row in the horizontal direction. In another example, when the first direction is vertical, the set of interactive buttons is arranged in a column in the vertical direction. The above examples are only used to describe the present disclosure, but are not specific limitations of the present disclosure.

For example, a set of interactive buttons may include a like button and a comment button. If the user likes the video 114, the user can click the like button to express his or her like for the video; if a user wants to comment on the video content, the user may comment on the video by selecting the comment button. In addition, as displayed on the display screen of the display device 112, a number of likes and a number of comments provided by the user can be further displayed, for example, the number of likes for the video is 167K, and the number of comments for the video is 5647. The above examples are only used to describe the present disclosure, but are not specific limitations of the present disclosure.

The content displayed on the display screen of the display device 112 may be controlled by the controller 102. The controller includes a plurality of control keys related to directions. Therefore, the controller may use the control key related to a first direction and/or a direction opposite to the first direction to switch the selection of interactive buttons, and use the control key related to a second direction and/or a direction opposite to the second direction to switch the video. Thus, the switching of the video displayed on a display layer and the switching of the interactive button can be controlled by the control keys related to the directions.

In some embodiments, the control key related to the first direction and/or the direction opposite to the first direction is a right key 106 and a left key 110; the control key related to the second direction and/or the direction opposite to the second direction is an up key 104 and a down key 108. At this time, the controller may control the selection of one of a set of interactive buttons through the left key 110 and the right key 106. The display device 112 switches the selection of the one of the set of interactive buttons after receiving a control signal of the left key 110 or the right key 106 from the controller 102. Similarly, the controller may control the selection of the video through the up key 104 and the down key 108. The display device 112 switches the video after receiving a control signal of the up key 104 or the down key 108 from the controller 102.

In some embodiments, the control keys related to the first direction and/or the direction opposite to the first direction are the up key 104 and the down key 108; the control keys related to the second direction and/or the direction opposite to the second direction are the right key 106 and the left key 110. At this time, the controller can control the selection of the videos through the right key 106 and the left key 110. Similarly, the controller can control the selection of a interactive button in a set of interactive buttons through the up key 104 and the down key 108. The above examples are only used to describe the present disclosure, but not to specifically limit the present disclosure. Those skilled in the art may set which direction control key is used to control the switching of the videos and which direction control key is used to control the switching of the selection of the interactive buttons according to their needs. In addition, the controller may also include other control keys for controlling the display device, such as a power key to turn the display device on or off. Through this method, when the user uses the controller to interact, the user can not only conveniently switch the video for browsing, but also efficiently use all the interactive buttons, thereby improving the usage efficiency and the user experience.

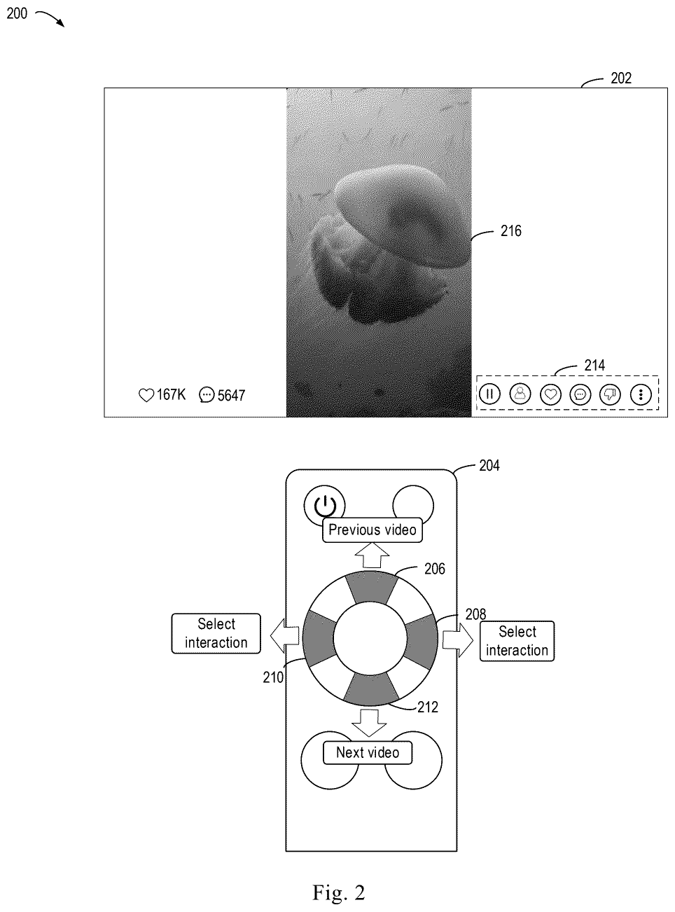

The above description in conjunction with FIG. 1 shows a schematic diagram of an example environment in which the device and/or method of embodiments of the present disclosure can be implemented. The following description in conjunction with FIG. 2 shows a schematic diagram of an example for browsing videos according to embodiments of the present disclosure.

In the example 200 shown in FIG. 2, a display content 202 on the display screen of the display device includes a video 216, and a set of interactive buttons 214 that may be used to interact with the user. The user may perform a predetermined interactive action, such as liking or giving a comment, by selecting an interactive button. The controller 204 includes an up key 206, a down key 212, a left key 210, and a right key 208. If the user presses the up key 206, the display device may switch a current video in the display content 202 to a previous video after receiving a control signal from the up key. If the user presses the down key 212, the display device may switch the current video in the display content 202 to the next video after receiving a control signal from the down key. If the user continuously clicks the down key or the up key, the display device continuously switches videos until the user stops clicking the up key or the down key.

If the user presses the left key 210, the display device may adjust the selected interactive button in the display content 202 to a next interactive button on the left after receiving the control signal from the left key. If the user presses the right key 208, the display device may adjust the selected interactive button in the display content 202 to the next interactive button on the right after receiving the control signal from the right key. If the user continuously clicks the right key 208 or the left key 210, the selection of the interactive button is continuously switched.

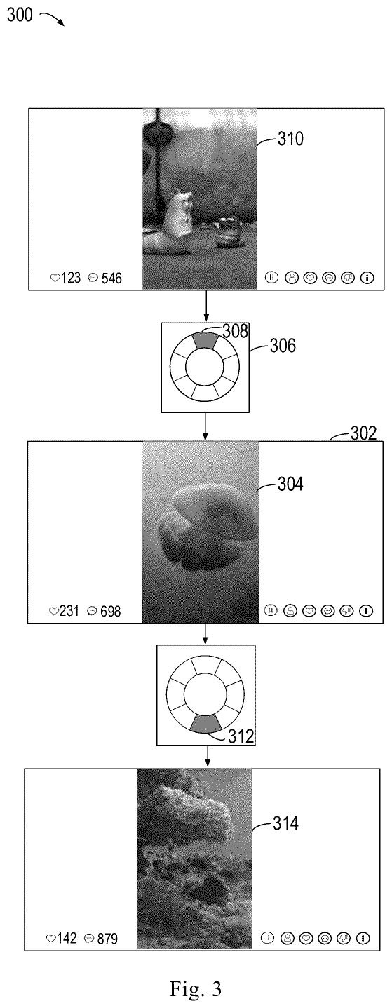

The above describes a schematic diagram of an example for browsing videos according to embodiments of the present disclosure in conjunction with FIG. 2, and the following further describes a schematic diagram of an example for switching video according to embodiments of the present disclosure in conjunction with FIG. 3.

In the example 300 shown in FIG. 3, a video 304 is included in a display content 302. After the user clicks the up key 308 through the controller 306, the video 304 included in the display content is switched to a previous video 310 in a video queue. If the user clicks the down key 312 through the controller, the video 304 included the display content is switched to the next video 314 in the video queue.

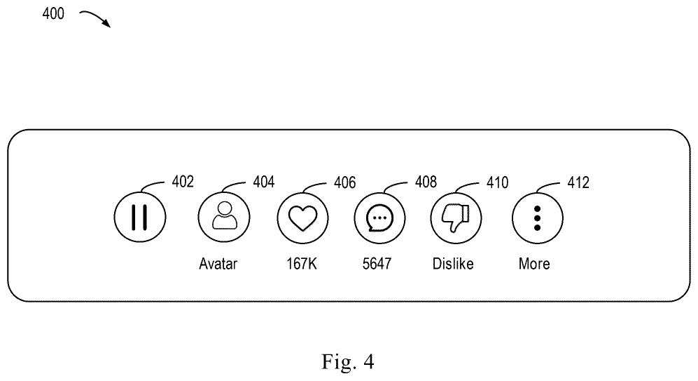

The following describes a schematic diagram of an example of interactive buttons according to embodiments of the present disclosure in conjunction with FIG. 4. In the example 400, a set of interactive buttons includes a pause button 402, which can be used to pause video playback. When the user selects the button through the controller, the video being played is paused. The set of interactive buttons also includes a profile or avatar button 404, which is used to present the user's profile information or avatar information. The set of interactive buttons also includes a like button 406 and a dislike button 410, which are used to indicate whether the user likes the video, and the display device may also display a number of likes and dislikes given by users. In addition, the set of interactive buttons also includes a comment button 408. When the user selects the comment button, a comment area may be provided to enter comments and view other users' comments. The set of interactive buttons also includes a more button 412, which can be selected to view more interactive buttons. The above example is only used to describe the present disclosure, and those skilled in the art can set a number of interactive buttons in a set of interactive buttons and the functions and uses of the interactive buttons as needed.

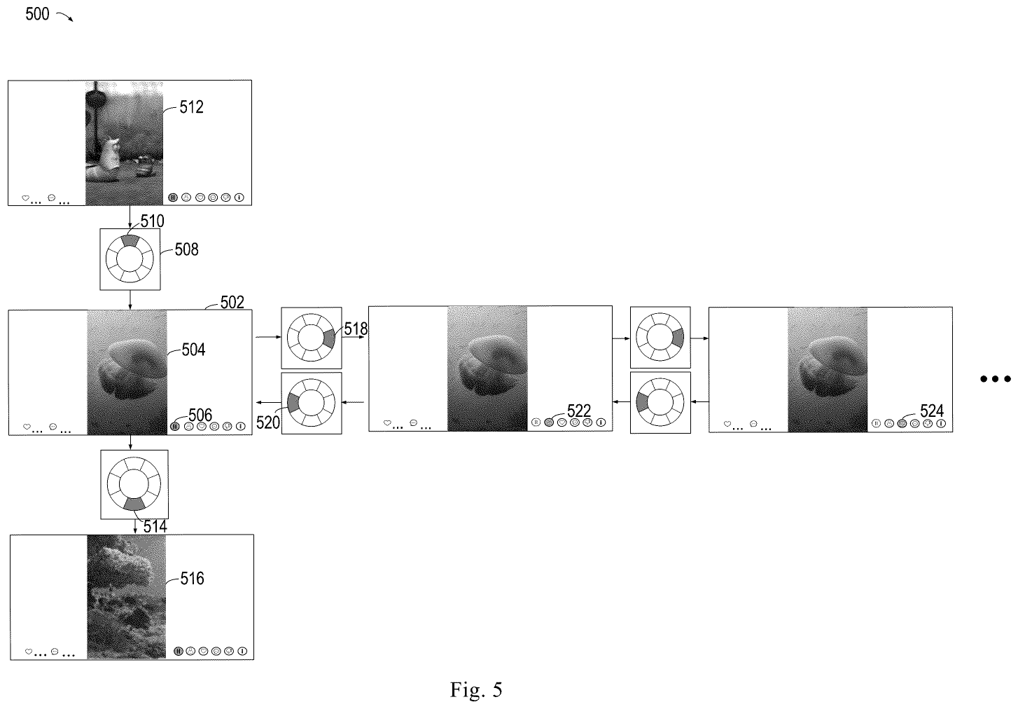

The following describes a schematic diagram of an example for switching interactive buttons according to embodiments of the present disclosure in conjunction with FIG. 5. In example 500, a video 504 is displayed in a display content 502. If the user clicks the up key 510 in the controller 508, the video 504 is switched to the previous video 512 in a video queue. If the user clicks the down key 514 in the controller 508, the video 504 is switched to the next video 516 in the video queue.

The user is watching the video 504. If the first interactive button 506, such as the pause button, is selected, when the user clicks the right key 518 in the controller, the next interactive button 522 will be displayed as selected on the display content. Similarly, if the user continues to click the right key 518, the third interactive button 524 is selected. Conversely, if the user clicks the left key 520 after selecting the third interactive button 524, the interactive button 522 on the left side of the interactive button 524 can be selected. If the left key 520 is continued to be clicked, the interactive button 506 can be further selected. The example shown in FIG. 5 shows that the videos are switched by the up key or the down key, and the selections of the interactive buttons are switched by the left key or the right key.

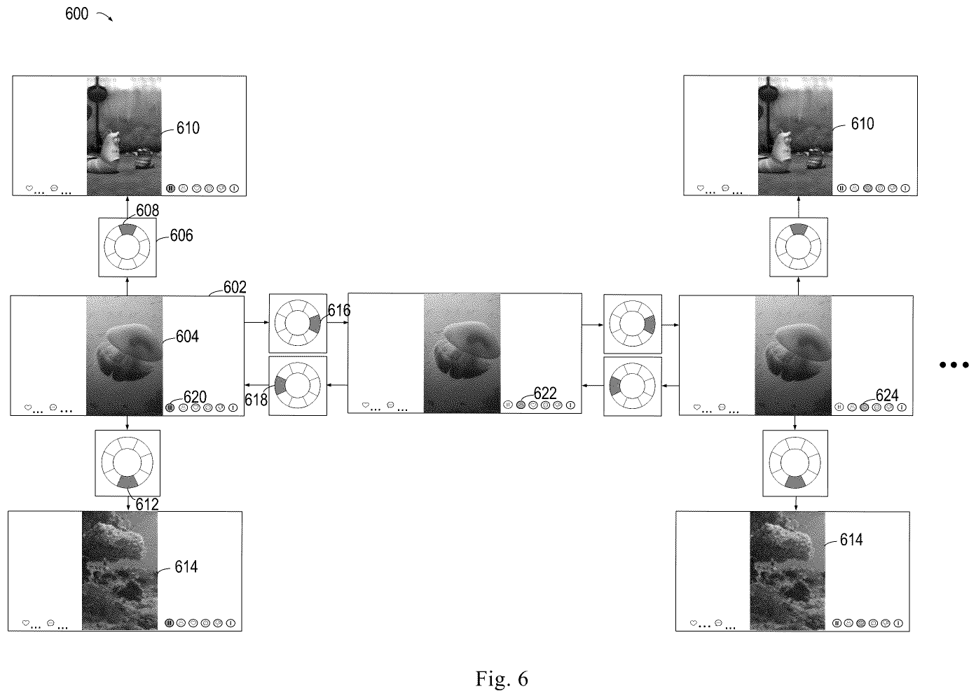

FIG. 6 illustrates a schematic diagram of an example for switching videos and interactive buttons according to embodiments of the present disclosure. The example 600 shown in FIG. 6 is similar to the example shown in FIG. 5. A video 604 and an interactive button 620 selected by the user are displayed in a display content 602. If the user clicks the up key 608 in the controller 606, the video 604 is switched to the previous video 610 in the video queue. During the video switching process, the selected interactive button remains unchanged and is always selected during this process. If the user clicks the down key 612 in the controller 606, the video 604 is switched to the next video 614 in the video queue. During the video switching process, the selected interactive button remains unchanged.

When the user is watching video 604, if the first interactive button is selected (for example the pause button 620 is selected), then when the user clicks the right key 616 in the controller, the next interactive button 622 will be displayed as selected on the display content. Similarly, if the right key 616 is continued to be clicked, the third interactive button 624 will be selected. If the user clicks the up key 608 at this time, the video can be switched to the previous video 610 while the interactive button 624 is selected; similarly, if the user clicks the down key 612 at this time, the video can be switched to the next video 614 while the interactive button 624 is selected. Conversely, if the user clicks the left key 618, the interactive button one the left side of the current interactive button can be selected. The example shown in FIG. 6 shows that the selections of the interactive button are switched by the left or right key, the videos are switched by the up or down key, and the selection of the interactive button is not changed when the video is switched.

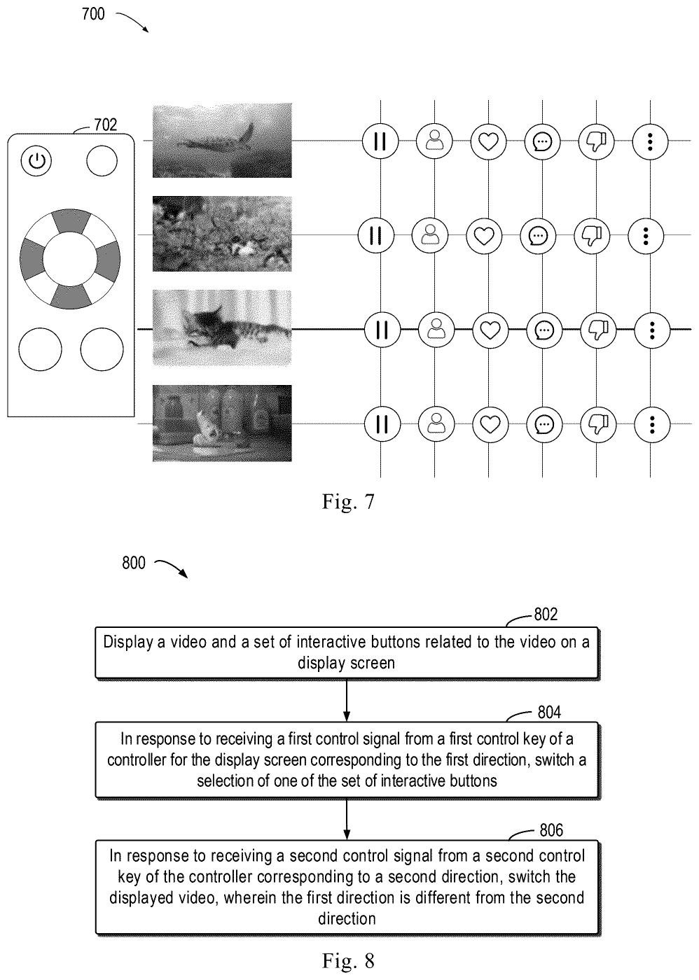

FIG. 7 illustrates a schematic diagram of an example of a mesh interactive structure according to an embodiment of the present disclosure. In example 700, a controller 702 is used to control an interactive grid of videos and interactive buttons. When the up key or down key is clicked, only the selection for videos in one column of videos in the grid is changed. When the selected video is changed, the selected interactive button is not changed. When the left or right key is clicked, only the selection for interactive buttons in one row of interactive buttons in the grid is changed.

The above describes an example of using the up key and the down key to switch videos and using the left key and the right key to switch the selection of interactive buttons in embodiments of the present disclosure in combination with FIG. 2-FIG. 3 and FIG. 5-FIG. 7. In some embodiments, the left key and the right key may be used to switch videos, and the up key and the down key may be used to switch the selection of interactive buttons. The operation method is similar to the above-described use of the up key and the down key to switch videos and the above-described use of the left key and the right key to switch the selection of interactive buttons. The above examples are only used to describe the present disclosure, and are not specific limitations of the present disclosure. Those skilled in the art can use any suitable direction-related keys to implement the above operations.

The following describes a schematic diagram of a method for browsing videos according to embodiments of the present disclosure in conjunction with FIG. 8. The process shown in FIG. 8 may be performed at the display device 112 shown in FIG. 1 or at any other suitable computing device.

At box 802, the display device displays a video and a set of interactive buttons related to the video on a display screen, and the set of interactive buttons are arranged in a first direction on the display screen. In order to facilitate the selection of the video and the interactive buttons, the display device sets the video and the set of interactive buttons to be displayed on a window level. Thus, the video and the set of interactive buttons can be controlled at the same time.

At box 804, in response to receiving a first control signal from a first control key of a controller for the display screen corresponding to a first direction, the display device switches a selection of one of a set of interactive buttons. After receiving the signal of the control key related to the first direction, the display device may determine that the user wants to switch the selected interactive button.

In some embodiments, when receiving the first control signal to switch the selected interactive button, the display device needs to first determine the first interactive button currently selected in the set of interactive buttons. Next, the display device needs to further determine whether there is an adjacent second interactive button on the display in the direction corresponding to the control signal. If the second interactive button exists on one side of the first interactive button corresponding to the first direction, the selection of the first interactive button is switched to the selection of the second interactive button. In one example, if the second interactive button docs not exist on the one side of the first interactive button corresponding to the first direction, the selection of the first interactive button is switched to a selection of a third interactive button in a set of interactive buttons farthest from the first interactive button.

For example, if the currently selected interactive button is the third button in a row of buttons and there is an adjacent interactive button in the direction corresponding to the first control signal, the selection of the third interactive button is switched to the selection of the adjacent interactive button. If the currently selected interactive button is the first or last interactive button and there is no more interactive button in the direction corresponding to the first control signal, a farthest interactive button may be selected. For example, the currently selected interactive button is the first interactive button and the first control signal indicates to select an interactive button on the left side of the first interactive button. Since there is no interactive button on the left side of the first interactive button, an interactive button farthest from the first interactive button (that is, the last interactive button) may be selected at this time. Therefore, the selection may be cyclic.

Alternatively, if there is no second interactive button on the side of the first interactive button corresponding to the first direction, the selection of the interactive button may not be switched. For example, the currently selected interactive button is the first interactive button, and the first control signal indicates to select the interactive button on the left side of the first interactive button. Since there is no interactive button on the left side of the first interactive button, the switching operation is no longer performed at this time.

In some embodiments, when determining whether there is a second interactive button of a set of interactive buttons adjacent to the first interactive button, if the first control key is a left key, the display device determines whether there is a second interactive button adjacent to the first interactive button on the left side of the first interactive button on the display screen. If the first control key is a right key, the display device determines whether there is a second interactive button adjacent to the first interactive button on the right side of the first interactive button on the display screen.

At box 806, in response to receiving a second control signal from a second control key of the controller corresponding to the second direction, the display device switches the displayed video, and the first direction is different from the second direction. If the display device receives a control signal related to the second direction, the video is switched.

In some embodiments, when a second control signal is received from a second control key of the controller corresponding to a second direction, the display device switches the first video being displayed on the display screen to a second video adjacent to the first video in a video play queue.

In some embodiments, when the first video is switched to the second video adjacent to the first video in the video play queue on the display screen, if the second control key is an up key, the previous video before the first video in the video play queue is determined as the second video, and then the first video on the display screen is switched to the second video for playback. If the second control key is a down key, the next video after the first video in the video play queue is determined as the second video; then, the first video on the display screen is switched to the second video for playback.

In some embodiments, when the displayed video is switched according to the second control signal, a fourth interactive button that has been selected in a set of interactive buttons when the first video is displayed can be determined. After the first video is switched to the second video, the selection of the fourth interactive button is maintained. At this time, although the video is switched, the interactive button selected by the user remains unchanged, which can improve the efficiency of the user's interaction and improve the user 106 experience.

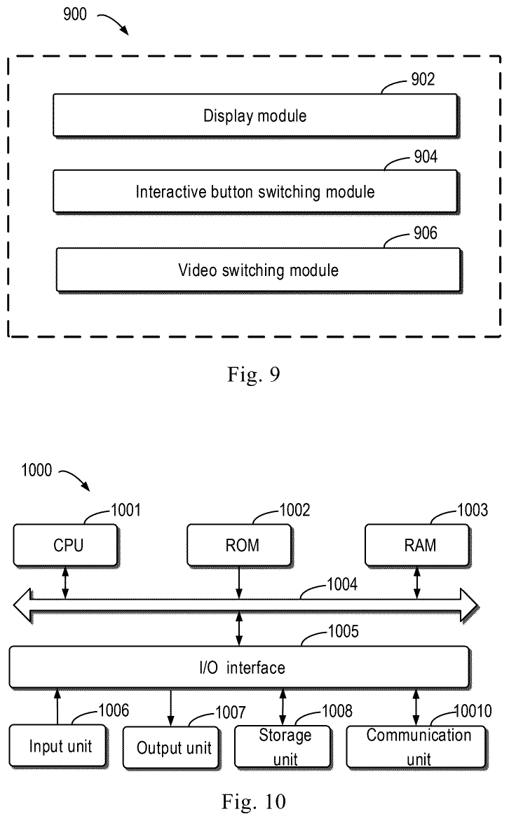

FIG. 9 shows a schematic block diagram of an apparatus for browsing videos according to an embodiment of the present disclosure. As shown in FIG. 9, the device 900 includes a display module 902 configured to display a video and a set of interactive buttons related to the video on a display screen, wherein the set of interactive buttons are arranged in a first direction on the display screen; an interactive button switching module 904 configured to in response to receiving a first control signal from a first control key of a controller for the display screen corresponding to the first direction, switch a selection of one of the set of interactive buttons; and a video switching module 906 configured to in response to receiving a second control signal from a second control key of the controller corresponding to a second direction, switch the displayed video, wherein the first direction is different from the second direction.

In some embodiments, the interactive button switching module 904 includes: a first interactive button determination module configured to in response to receiving the first control signal, determine a first interactive button in a set of interactive buttons that has been selected; a first adjacent button determination module configured to determine whether there is a second interactive button in a set of interactive buttons adjacent to the first interactive button on one side of the first interactive button corresponding to the first direction; and a first switching module configured to in response to a presence of the second interactive button on one side of the first interactive button corresponding to the first direction, switch the selection of the first interactive button to the selection of the second interactive button.

In some embodiments, the interactive button switching module 904 also includes: a second switching module configured to in response to an absence of the second interactive button on the side of the first interactive button corresponding to the first direction, switch a selection of the first interactive button to a selection of the third interactive button in a set of interactive buttons farthest from the first interactive button.

In some embodiments, the first control key is a left key, and the first adjacent button determination module includes: a left key determination block configured to determine whether there is a second interactive button adjacent to the first interactive button on a left side of the first interactive button on the display screen.

In some embodiments, the first control key is a right key, and the first adjacent button determination module includes: a right key determination block configured to determine whether there is a second interactive button adjacent to the first interactive button on a right side of the first interactive button on the display screen.

In some embodiments, the video switching module 906 includes: a switching module configured to in response to receiving the second control signal, switch the first video being displayed on the display screen to a second video that is adjacent to the first video in the video play queue.

In some embodiments, the second control key is an up key, and the switching module includes: a previous video determination module configured to determine a previous video in the video play queue that is located before the first video; and a second video determination module configured to determine the previous video as the second video; and a first switching module configured to switch the first video on the display screen to the second video.

In some embodiments, the second control key is a down key, and the switching module includes: a next video determination module configured to determine the next video in the video play queue that is located after the first video; and a third video determination module configured to determine the next video as the second video; and a second switching module configured to switch the first video on the display screen to the second video.

In some embodiments, the video switching module 906 further includes: a third interactive button determination module that determines a fourth interactive button in a set of interactive buttons that has been selected when displaying the first video; and a maintaining module configured to maintain a selection of the fourth interactive button after switching the first video to the second video.

FIG. 10 shows a schematic block diagram of an example device 1000 that can be used to implement embodiments of the present disclosure. The display device 112 in FIG. 1 can be implemented using the device 1000. As shown, the device 1000 includes a central processing unit (CPU) 1001, which can perform various appropriate actions and processes according to computer program instructions stored in a read-only memory (ROM) 1002 or loaded from a storage unit 1008 into a random access memory (RAM) 1003. In the RAM 1003, various programs and data required for the operation of the device 1000 may also be stored. A CPU 1001, a ROM 1002, and a RAM 1003 are connected to each other via a bus 1004. An input/output (I/O) interface 1005 is also connected to the bus 1004.

Multiple components in the device 1000 are connected to the I/O interface 1005, including: an input unit 1006, such as a keyboard, a mouse, etc.; an output unit 1007, such as various types of displays, speakers, etc.; a storage unit 1008, such as a disk, an optical disk, etc.; and a communication unit 1009, such as a network card, a modem, a wireless communication transceiver, etc. The communication unit 1009 allows the device 1000 to exchange information/data with other devices via a computer network such as the Internet and/or various telecommunication networks.

The various processes and processing described above, such as method 800, may be performed by the processing unit 1001. For example, in some embodiments, the method 800 may be implemented as a computer software program that is tangibly contained in a machine-readable medium, such as the storage unit 1008. In some embodiments, part or all of the computer program may be loaded and/or installed on the device 1000 via the ROM 1002 and/or the communication unit 1009. When the computer program is loaded into the RAM 1003 and executed by the CPU 1001, one or more actions of the method 800 described above may be performed.

The present disclosure may be a method, an apparatus, a system and/or a computer program product. The computer program product may include a computer-readable storage medium having computer-readable program instructions for performing various aspects of the present disclosure.

The computer-readable storage medium may be a tangible device that can retain and store instructions used by an instruction execution device. Computer-readable storage media may be, for example, but not limited to, electrical storage devices, magnetic storage devices, optical storage devices, electromagnetic storage devices, semiconductor storage devices, or any suitable combination of the above. More specific examples of computer-readable storage media (a non-exhaustive list) include: portable computer disks, hard disks, a random access memory (RAM), a read-only memory (ROM), an erasable programmable read-only memory (EPROM or flash memory), a static random access memory (SRAM), a portable compact disk read-only memory (CD-ROM), a digital versatile disk (DVD), a memory stick, a floppy disk, mechanical encoding devices, such as punch cards or raised structures in grooves on which instructions are stored, and any suitable combination of the above. Computer-readable storage media as used herein are not to be interpreted as transient signals per se, such as radio waves or other freely propagating electromagnetic waves, electromagnetic waves propagating through waveguides or other transmission media (e.g., light pulses through fiber-optic cables), or electrical signals transmitted through wires.

The computer-readable program instructions described herein may be downloaded from a computer-readable storage medium to each computing/processing device, or downloaded to an external computer or external storage device via a network, such as the internet, a local area network, a wide area network, and/or a wireless network. The network may include copper transmission cables, optical fiber transmission, wireless transmission, routers, firewalls, switches, gateway computers, and/or edge servers. The network adapter card or network interface in each computing/processing device receives the computer-readable program instructions from the network and forwards the computer-readable program instructions for storage in a computer-readable storage medium in each computing/processing device.

The computer program instructions for performing the operations of the present disclosure may be assembly instructions, instruction set architecture (ISA) instructions, machine instructions, machine-dependent instructions, microcode, firmware instructions, state setting data, or source code or object code written in any combination of one or more programming languages, including object-oriented programming languages, such as Smalltalk, C++, etc., and conventional procedural programming languages, such as “C” or similar programming languages. The computer-readable program instructions may be executed entirely on the user's computer, partially on the user's computer, as a stand-alone software package, partially on the user's computer and partially on a remote computer, or entirely on a remote computer or server. In the case of a remote computer, the remote computer may be connected to the user's computer via any type of network, including a local area network (LAN) or a wide area network (WAN), or may be connected to an external computer (e.g., via the internet using an internet service provider). In some embodiments, the state information of the computer-readable program instructions is used to personalize an electronic circuit, such as a programmable logic circuit, a field programmable gate array (FPGA), or a programmable logic array (PLA), which may execute the computer-readable program instructions to implement various aspects of the present disclosure.

Various aspects of the present disclosure are described herein with reference to flowcharts and/or block diagrams of methods, apparatus (systems), and computer program products according to embodiments of the present disclosure. It should be understood that each block of the flowchart and/or block diagram, as well as combinations of blocks in the flowchart and/or block diagram, may be implemented by computer-readable program instructions.

These computer-readable program instructions may be provided to a processing unit of a general-purpose computer, a special-purpose computer, or other programmable data processing device, thereby producing a machine such that when these instructions are executed by the processing unit of the computer or other programmable data processing device, an apparatus is produced that implements the functions/actions specified in one or more blocks in the flowchart and/or block diagram. These computer-readable program instructions may also be stored in a computer-readable storage medium, where these instructions cause the computer, programmable data processing devices, and/or other devices to operate in a specific manner, so that the computer-readable medium storing the instructions comprises an article of manufacture that includes instructions for implementing various aspects of the functions/actions specified in one or more blocks in the flowchart and/or block diagram.

The computer-readable program instructions may also be loaded onto a computer, other programmable data processing device, or other device, so that a series of operational steps are performed on the computer, other programmable data processing device, or other device to produce a computer-implemented process, so that the instructions executed on the computer, other programmable data processing device, or other device implement the functions/actions specified in one or more blocks in the flowchart and/or block diagram.

The flowcharts and block diagrams in the drawings illustrate possible architectures, functions, and operations of systems, methods, and computer program products according to various embodiments of the present disclosure. In this regard, each box in a flowchart or block diagram may represent a module, program segment, or a portion of an instructions, which contains one or more executable instructions for implementing a specified logical function. In some alternative implementations, the functions marked in the blocks may also occur in an order different from that marked in the accompanying drawings. For example, two consecutive boxes may actually be executed substantially in parallel, and they may sometimes be executed in reverse order, depending on the functions involved. It should also be noted that each block in the block diagram and/or flowchart, and the combination of blocks in the block diagram and/or flowchart, may be implemented by a dedicated hardware-based system that performs the specified function or action, or may be implemented by a combination of dedicated hardware and computer instructions.

The various embodiments of the present disclosure have been described above, and the above description is exemplary, not exhaustive, and is not limited to the disclosed embodiments. Without departing from the scope and spirit of the various embodiments described, many modifications and variations are apparent to those of ordinary skill in the art. The selection of terms used herein is intended to best explain the principles of the various embodiments, practical applications, or technical improvements to the technology in the market, or to enable other ordinary technicians in the art to understand the various embodiments disclosed herein.

I/We claim:

1. A method for browsing videos, comprising:
displaying a video and a set of interactive buttons related to the video on a display screen, wherein the set of interactive buttons is arranged in a first direction on the display screen;
in response to receiving a first control signal from a first control key of a controller for the display screen corresponding to the first direction, switching a selection of one of the set of interactive buttons; and
in response to receiving a second control signal from a second control key of the controller corresponding to a second direction, switching the displayed video, wherein the first direction is different from the second direction.

2. The method according to claim 1, wherein in response to receiving a first control signal from a first control key of a controller for the display screen corresponding to the first direction, switching a selection of one of the set of interactive buttons comprises:
in response to receiving the first control signal, determining a first interactive button in the set of interactive buttons that has been selected;
determining whether there is a second interactive button in the set of interactive buttons adjacent to the first interactive button on one side of the first interactive button corresponding to the first direction; and
in response to a presence of the second interactive button on one side of the first interactive button corresponding to the first direction, switching a selection of the first interactive button to a selection of the second interactive button.

3. The method according to claim 2, wherein in response to receiving a first control signal from a first control key of a controller for the display screen corresponding to the first direction, switching a selection of one of the set of interactive buttons further comprises:
in response to an absence of the second interactive button on the side of the first interactive button corresponding to the first direction, switching a selection of the first interactive button to a selection of a third interactive button in the set of interactive buttons farthest from the first interactive button.

4. The method according to claim 2, wherein the first control key is a left key, and determining whether there is a second interactive button in the set of interactive buttons adjacent to the first interactive button on one side of the first interactive button corresponding to the first direction comprises:
determining whether there is a second interactive button adjacent to the first interactive button on a left side of the first interactive button on the display screen.

5. The method according to claim 2, wherein the first control key is a right key, and determining whether there is a second interactive button in the set of interactive buttons adjacent to the first interactive button on one side of the first interactive button corresponding to the first direction comprises:
determining whether there is a second interactive button adjacent to the first interactive button on a right side of the first interactive button on the display screen.

6. The method according to claim 1, wherein in response to receiving a second control signal from a second control key of the controller corresponding to a second direction, switching the displayed video comprises:
in response to receiving the second control signal, switching the first video being displayed on the display screen to a second video that is adjacent to the first video in a video play queue.

7. The method according to claim 6, wherein the second control key is an up key, and switching the first video being displayed on the display screen to a second video that is adjacent to the first video in a video play queue comprises:
determining a previous video in the video play queue that is located before the first video; and
determining the previous video as the second video; and
switching the first video on the display screen to the second video.

8. The method according to claim 6, wherein the second control key is a down key, and switching the first video being displayed on the display screen to a second video that is adjacent to the first video in a video play queue comprises:
determining a next video in the video play queue that is located after the first video;
determining the next video as the second video; and
switching the first video on the display screen to the second video.

9. The method according to claim 6, wherein in response to receiving a second control signal from a second control key of the controller corresponding to a second direction, switching the displayed video further comprises:
determining a fourth interactive button in the set of interactive buttons that has been selected when displaying the first video; and
maintaining a selection of the fourth interactive button after switching the first video to the second video.

10. A display device, comprising:
at least one processor; and
a memory having at least one program stored thereon which, when executed by the at least one processor, causes the at least one processor to implement operations comprising:
displaying a video and a set of interactive buttons related to the video on a display screen, wherein the set of interactive buttons is arranged in a first direction on the display screen;
in response to receiving a first control signal from a first control key of a controller for the display screen corresponding to the first direction, switching a selection of one of the set of interactive buttons; and
in response to receiving a second control signal from a second control key of the controller corresponding to a second direction, switching the displayed video, wherein the first direction is different from the second direction.

11. The display device according to claim 10, wherein in response to receiving a first control signal from a first control key of a controller for the display screen corresponding to the first direction, switching a selection of one of the set of interactive buttons comprises:
in response to receiving the first control signal, determining a first interactive button in the set of interactive buttons that has been selected;
determining whether there is a second interactive button in the set of interactive buttons adjacent to the first interactive button on one side of the first interactive button corresponding to the first direction; and
in response to a presence of the second interactive button on one side of the first interactive button corresponding to the first direction, switching a selection of the first interactive button to a selection of the second interactive button.

12. The display device according to claim 11, wherein in response to receiving a first control signal from a first control key of a controller for the display screen corresponding to the first direction, switching a selection of one of the set of interactive buttons further comprises:
in response to an absence of the second interactive button on the side of the first interactive button corresponding to the first direction, switching a selection of the first interactive button to a selection of a third interactive button in the set of interactive buttons farthest from the first interactive button.

13. The display device according to claim 11, wherein the first control key is a left key, and determining whether there is a second interactive button in the set of interactive buttons adjacent to the first interactive button on one side of the first interactive button corresponding to the first direction comprises:
determining whether there is a second interactive button adjacent to the first interactive button on a left side of the first interactive button on the display screen.

14. The display device according to claim 11, wherein the first control key is a right key, and determining whether there is a second interactive button in the set of interactive buttons adjacent to the first interactive button on one side of the first interactive button corresponding to the first direction comprises:
determining whether there is a second interactive button adjacent to the first interactive button on a right side of the first interactive button on the display screen.

15. The display device according to claim 10, wherein in response to receiving a second control signal from a second control key of the controller corresponding to a second direction, switching the displayed video comprises:
in response to receiving the second control signal, switching the first video being displayed on the display screen to a second video that is adjacent to the first video in a video play queue.

16. The display device according to claim 5, wherein the second control key is an up key, and switching the first video being displayed on the display screen to a second video that is adjacent to the first video in a video play queue comprises:
determining a previous video in the video play queue that is located before the first video; and
determining the previous video as the second video; and
switching the first video on the display screen to the second video.

17. The display device according to claim 15, wherein the second control key is a down key, and switching the first video being displayed on the display screen to a second video that is adjacent to the first video in a video play queue comprises:
determining a next video in the video play queue that is located after the first video;
determining the next video as the second video; and
switching the first video on the display screen to the second video.

18. The display device according to claim 15, wherein in response to receiving a second control signal from a second control key of the controller corresponding to a second direction, switching the displayed video further comprises:
determining a fourth interactive button in the set of interactive buttons that has been selected when displaying the first video; and
maintaining a selection of the fourth interactive button after switching the first video to the second video.

19. A non-transitory computer-readable storage medium having a computer program stored thereon which, when executed by a processor, causes the processor to implement operations comprising:
displaying a video and a set of interactive buttons related to the video on a display screen, wherein the set of interactive buttons is arranged in a first direction on the display screen;
in response to receiving a first control signal from a first control key of a controller for the display screen corresponding to the first direction, switching a selection of one of the set of interactive buttons; and
in response to receiving a second control signal from a second control key of the controller corresponding to a second direction, switching the displayed video, wherein the first direction is different from the second direction.

20. The non-transitory computer-readable storage medium according to claim 19, wherein in response to receiving a first control signal from a first control key of a controller for the display screen corresponding to the first direction, switching a selection of one of the set of interactive buttons comprises:
in response to receiving the first control signal, determining a first interactive button in the set of interactive buttons that has been selected;
determining whether there is a second interactive button in the set of interactive buttons adjacent to the first interactive button on one side of the first interactive button corresponding to the first direction; and
in response to a presence of the second interactive button on one side of the first interactive button corresponding to the first direction, switching a selection of the first interactive button to a selection of the second interactive button.
